(19) United States
(12) Patent Application Publication
(10) Pub. No.: US 2005/0012716 A1
(43) Pub. Date: Jan. 20, 2005

(54) Sensing apparatus

(76) Inventors: Dominic Josef Mikulin, Herts (GB); Richard Wilhelm Janse Van Rensburg, Cambridge (GB); Robert Gordon Maurice Selby, Herts (GB)

Correspondence Address: Bond Schoeneck & King, One Lincoln Center, Syracuse, NY, 13202-1355, US

(21) Appl. No.: 10/493,929

(22) PCT Filed: Oct. 24, 2002
(86) PCT No.: PCT/GB02/04817

(30) Foreign Application Priority Data
Oct. 24, 2001 (GB) 0125529.8

(51) Int. Cl. G01B 7/14; G09G 5/08

(52) U.S. Cl. 345/163; 324/207.11

(57) ABSTRACT

A sensing apparatus for detecting a translation of a body relative to a surface, the apparatus comprising: a rolling component for contact, in use, with the surface, the rolling component being retained by, and able, in use, to rotate independently of the body; one or more indicator means associated with the rolling component and rotatable therewith; and one or more transducers for producing one or more signals in response to a rotation of the indicator means relative to the one or more transducers wherein, in use, the rolling component rolls upon the surface in response to a relative translation of the body to the surface, thereby causing the positional orientation of the indicator means to change with respect to the transducers.

### CROSS-REFERENCE TO RELATED APPLICATIONS

The present application is the U.S. National Stage filing under 35 U.S.C. § 371 of International Application No. PCT/GB02/04817 filed Oct. 24, 2002 and published on May 1, 2003 as Publication No. WO 03/036560, which claims priority to UK Application No. 0125529.8, filed Oct. 24, 2001.

### BACKGROUND OF THE INVENTION

This invention relates to a sensing apparatus and, in particular, a sensing apparatus for detecting the translation of a body relative to a surface.

Prior known sensors have either detected movement per se or specific movement in one or more directions. Such sensors have been incorporated in hand-held devices.

Well known hand-held input devices which allow the user of such devices to interact with computer generated environments include touch screens, track balls, mice, joysticks, gloves, digitising tablets with styli and light pens interacting on electronic write boards. A number of these are designed principally to be “easy to use” and so have a degree of accuracy which allows them only to be of use in the directional control or pointing of a cursor. Many of these cannot be used in a natural writing position and so cannot easily generate information related to written characters or shapes which can be captured and further analysed.

Those devices which can be held in a natural writing position, such as light pens or digitising tablets, can only be used to a generate information by using two distinct parts, whether the parts are tethered or wireless, and therefore they are expensive, cumbersome and impractical to use as portable devices, i.e. when the user is traveling.

Accordingly, it is an aim of the present invention to provide a sensing apparatus, which can be used in a hand-held input device such as a stylus or pen, which can be used in a natural writing position to generate information relating to written characters or shapes.

### BRIEF SUMMARY OF THE INVENTION

According to the present invention, there is provided a sensing apparatus for detecting a translation of a body relative to a surface, the apparatus comprising: a rolling component for contact, in use, with the surface, the rolling component being retained by and able, in use, to rotate independently of, the body; one or more indicator means associated with the rolling component and rotatable therewith; and one or more transducers for producing one or more signals in response to a rotation of the indicator means relative to the one or more transducers; wherein, in use, the rolling component rolls upon the surface in response to a relative translation of the body to the surface, thereby causing the position or orientation of the indicator means to change with respect to the transducers.

The indicator means may be a permanent or temporary magnetic field in the rolling component and the magnetic field maybe anisotropic or inhomogeneous.

The indicator means may be generated by means external to the rolling component but could be changed by the characteristics of the surface of the rolling component. For example, the indicator means may be a coating on the surface of the rolling component, the coating being activated by an activation source. The coating may be phosphorescent, thermochromic, or thermal. The activation means may be a light source, a heat source or a magnetic field generator. The activation source may be pulsed.

Alternatively, or additionally, the indicator means may include markings on the surface of the rolling component.

The indicator means may be based on a transient field, which could be induced in part of the rolling component, and which decays over time. This may be magnetic field or decaying charge.

The one or more transducers may include magnetic field sensors, charge sensors or optical sensors for generating a signal in response to the relative rotation of the indicator means to the transducers. The signal produced by the transducers may be proportional to the sensed property or may be bistable about a threshold value.

The surface of the rolling component may include a surface coating of magnetisable material and there may be means for magnetising the surface coating and erasing means for removing the magnetisation after the transducers have produced the relevant signal. The erasing devices may be permanently switched on.

There may be a predefined pattern of magnetisation of the surface of the rolling component such as an array of dipoles on or in the surface of the rolling component. Alternatively, the rolling component itself may include one or more dipoles.

The rolling component is preferably formed from tungsten carbide.

The apparatus may include means for detecting temporary breaks in the movement of the rolling component when it is lifted from the surface, which means may be a pressure sensor.

There may be only one axis of rotation sensed.

The invention also includes an implement including a sensing apparatus as defined above, wherein the sensing apparatus is located in a tip of the implement and is used to track the motion of the tip over the surface.

The invention also includes an implement including a sensing apparatus as defined above, wherein the rolling component is located in a sensing point of the implement and is used to sense and track the motion of a surface in relation to the sensing point.

In either of the above the tip may be fed with ink which is then deposited onto the surface as the rolling component moves along the surface. In this case, the implement becomes a writing implement with incorporated sensors.

In the current preferred example, the method for detecting the position of a spherical object detects the magnetic field associated with the spherical object. To deduce information about the movement of the rolling object, it is necessary to ensure that the sensors are sampled frequently enough so that the rolling object cannot complete one or numbers of whole revolutions between sensor samples.

This technique can be applied to rolling objects which have freedom to rotate about any axis without restriction and can also be applied to articulated joints which have a restricted range of motion. Multiple sensors are required for detection of motion in more than one axis—at least one sensor per degree of freedom.

The position of the rolling object is detected through measuring the magnetic field at a number of positions around it. This is can be achieved by using an anisotropic magneto resistive (AMR) sensor or other sensor which detects magnetic field strength. This has the advantage over techniques which detect the rate of change of magnetic field in that the position rather than the motion of the spherical object can be detected and this functionality allows this technique to be applied to many applications. The ball does not need to be moving for its position to be determined. Also rotation speeds and accelerations are directly available by processing the signals from the sensors.

This technique can be used in conjunction with rolling objects which have one of the following permanent magnetic fields:

Simple magnetic dipole. This has the advantage of being the simplest and cheapest magnetic field to apply to a spherical object. Additionally the magnetic field strength for a given size of spherical object will be the highest for this form of magnetisation.

Curved magnetic dipole. This has the advantage of eliminating axial degeneracy associated with a simple dipole. This means that the case where the spherical object can rotate about the magnetic axis, and so eliminate any change in magnetic field measured by the sensors, is eliminated.

Multiple magnetic domains—quadrupole and multiple pole. Whilst creating a spherical object with 4 or multiple poles is more complicated than creating a single dipole (straight or curved) this magnetic field pattern has the advantage of providing finer resolution of position of a spherical object.

The preferred sensor arrangement incorporates a majorly or wholly spherical magnetised body—e.g. the former could be a ball and socket articulating joint, the latter a free ball.

In the latter case, for the ball to be able to rotate, it is necessary that it is held within a bearing that allows it to rotate freely. The ball can then respond to any applied rotational disturbance. The bearing may additionally require some form of static or hydrodynamic fluid lubrication to aid smooth and/or reliable operation.

For example, a sphere where the centre of mass is not in the physical centre of the ball can operate as a tilt sensor. Alternatively the ball could be pressed against a surface and rotate and the bearing is moved relative to that surface as in a rollerball pen or a 1 or 2 dimensional translation encoder.

If the ball housing is also sprung within its housing, position and motion in the third dimension (z) can be detected.

To achieve the required accuracy in this analogue system, the relative position of the sensors and ball to be fixed and well controlled to find the orientation of the ball requires.

Accurate machining of the ball housing can be used to fix this, but since in many cases the housing can actually wear during use, it would be advantageous to separate the ball and its housing from the sensor assembly. This will allow easy replacement of worn parts.

Once the system comprises two parts—the ball in its housing as one and the sensor assembly as the other, there is a requirement for accurate positioning of these two components relative to each other. Using the principles of kinematic theory of constraint, it is only necessary to constrain the bearing for the ball in three of its six degrees of freedom—those of translation, but in practice, given its geometry all six of its degrees of freedom end up constrained in operation.

Structures are required in the sensor assembly together with complementary structures in the ball housing that allow the ball housing to be pushed into position and locked.

Taking structures with rotational symmetry as an example, in two planes, say the x and y, three points of contact constrain that plane. Mating datum surfaces on the third plane complete the constraint. A mechanism is required to push the datum faces together and maintain their relative position. One example of this is a bayonet cap fitting.

Products which would incorporate the sensing apparatus of the present invention would range in functionality from text, or graphics, or velocity profile input.

### BRIEF DESCRIPTION OF THE DRAWINGS

Examples of the present invention will now be described with reference to the accompanying drawings, in which:

FIG. 1 is a schematic side view of one example of the present invention;

FIG. 2 is a plan view of the first example;

FIG. 3 is a schematic side view of a second example of the present invention;

FIG. 4 is a plan view of the second example;

FIG. 5 is a schematic side view of a third example of the present invention;

FIG. 6 is a plan view of the third example;

FIG. 7 is a schematic side view of a fourth example of the present invention;

FIG. 8 is a plan view of the fourth example;

FIG. 9 is a schematic side view of a fifth example of the present invention;

FIG. 10 is a plan view of the fifth example;

FIG. 11 is a schematic side view of a sixth example of the present invention;

FIG. 12 is a plan view of the sixth example;

FIG. 13 is a schematic side view of a seventh example of the present invention;

FIG. 14 is a plan view of the seventh example;

FIG. 15 is a schematic side view of an eighth example of the present invention;

FIG. 16 is a plan view of the eighth example;

FIGS. 17A to F show a ninth example of the present invention;

FIG. 18 is a plan view of the ninth example;

FIG. 19 is a schematic side view of a tenth example of the present invention;

FIG. 20 is a plan view of the tenth example;

FIG. 21 is a schematic cross section through a pen tip;

FIG. 22 is a schematic perspective view of a pen tip;

FIG. 23 is a schematic longitudinal cross sectional view of a sensing implement using the present invention;

FIG. 24 is a schematic longitudinal cross sectional view through the tip of the implement FIG. 23;

FIG. 25 is a graph showing an example of output voltages obtained experimentally from the implement of FIG. 23;

FIG. 26 is a graph showing the sensed line against the line vector drawn by the implement based on the sensor signals; and

FIGS. 27A and 27B are schematic perspective views of a refill and tip shroud for use in an implement such as that in FIG. 23.

### DETAILED DESCRIPTION OF THE INVENTION

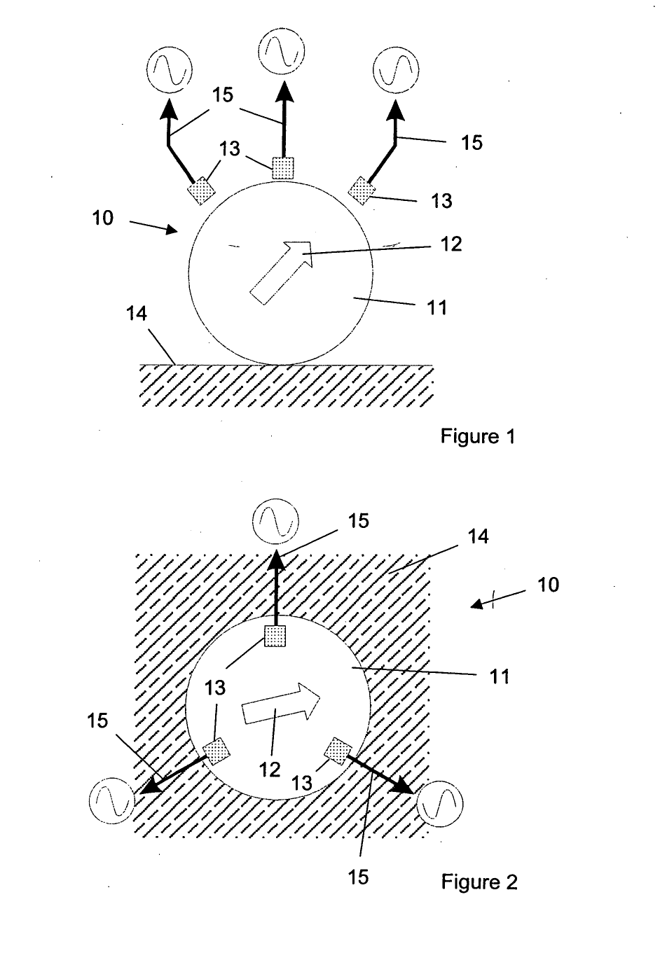

In FIG. 1, the sensing apparatus 10 comprises a spherical ball 11 which is magnetised with a dipole 12. The ball is typically 700-1000 μm in diameter. The ball is retained in a housing (not shown) of typical wall thickness of 100 μm in which three magnetic field sensors 13 are mounted. The sensors 13 are approximately 200 μm from the surface of the ball 11. In use, the ball 11 is placed in contact with surface 14 such that, as the body is moved relative to the surface, the ball 11 rotates relative to the magnetic field sensors 13. In this way, the orientation of the dipole changes, thereby altering the magnetic field around the ball. This alteration is then detected by the sensors 13. The sensors 13 convert the detected field change into continuously variable output signals 15.

The magnetic field sensors 13 are, in this example, thin film transducers. In this example three sensors are preferred to determine the motion of the ball 11. In the description of the remaining Figures, the same reference numerals have been used in respect of like features.

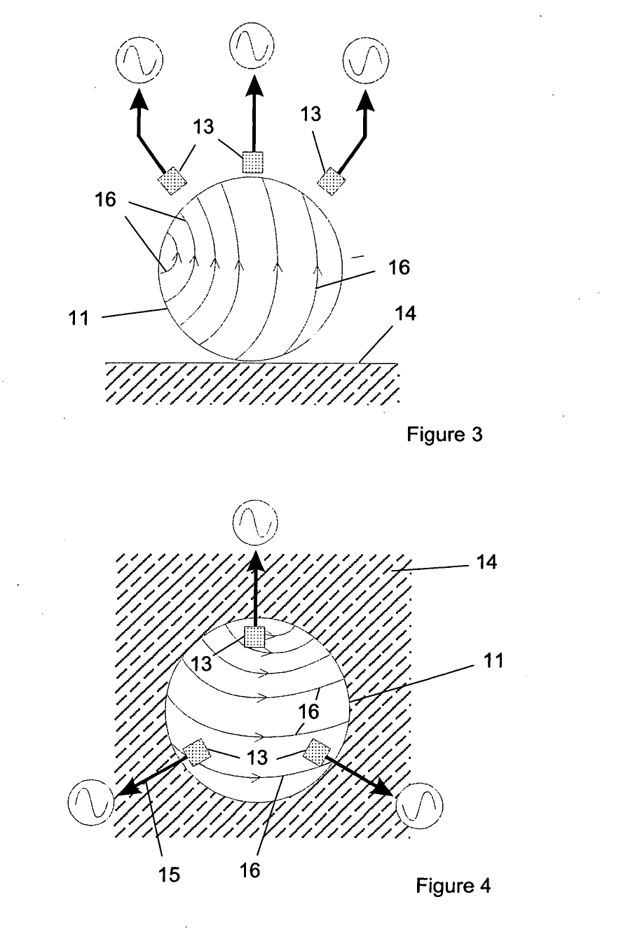

The second example shown in FIGS. 3 and 4 shows a different form of magnetic field on ball 11. In this case, the ball 11 is inhomogeneously magnetised and this is indicated by magnetic field lines 16 which are, of course, only a schematic representation of the magnetic field which could be of any suitable form. In this example, as ball 11 rotates with respect to sensors 13, the change in magnetic field is detected by sensors 13.

The magnetic field strength at the surface of the ball 11 is typically of the order of 1 to 100 Gauss, depending upon the material from which the ball 11 is formed.

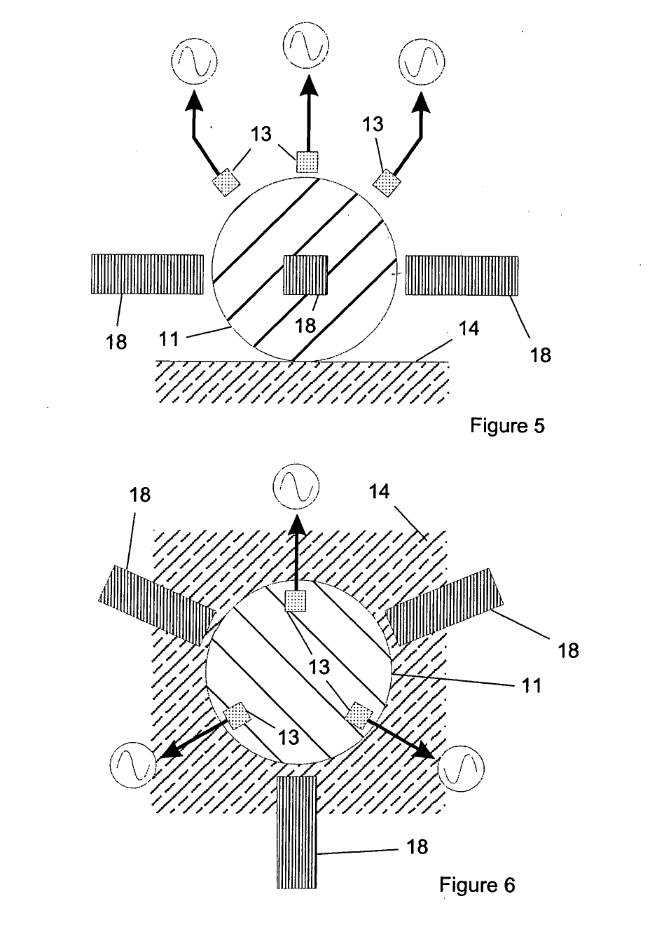

A third example of the present invention is shown in FIGS. 5 and 6 in which the ball 11 is provided with anisotropic or inhomogeneous magnetic permeability. The ball may or may not be intrinsically magnetised. An array of permanent or switchable electromagnets 18 are spaced around the ball 11 to control the strength of the magnetic field applied to the ball 11. In this arrangement, the electromagnets are arranged in a plane substantially parallel to the surface 14 and substantially at the midpoint of the ball 11.

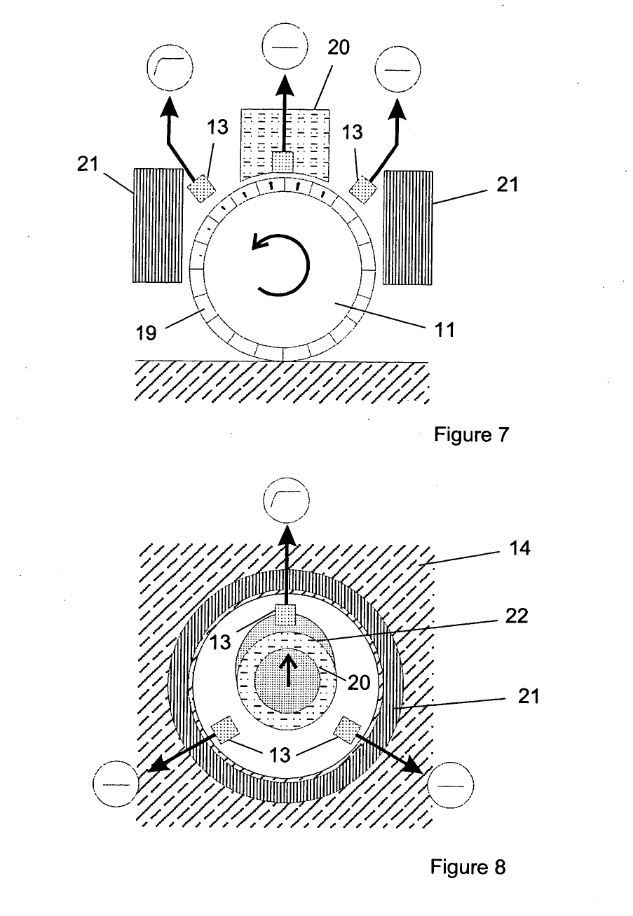

FIGS. 7 and 8 show a fourth example in which the ball 11 is provided with a surface coating 19 of a magnetisable material such as ferric oxide e.g. as in a magnetic tape. A write head 20, located, as can be seen from FIG. 8, over the centre of the ball 11 in plan view, imposes a magnetised region 22 on the surface layer 19. This magnetised region is detected by the sensors as the ball 11 rotates. The region is erased when exposed to the erase field provided by erase heads 21. In this example, the erase heads 21 are permanently on but they could be controlled such that they are activated only when required. The rotational speed of the ball 11 would determine the read head signal strength and the direction of rotation is given by the correlation between the sensor signals.

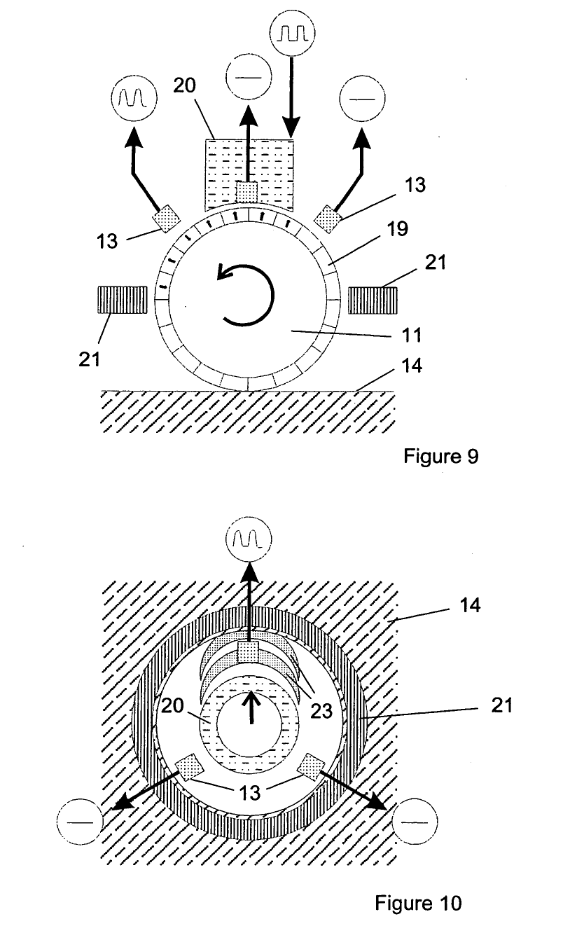

The fifth example shown in FIGS. 9 and 10 shows a centrally located write head 20, as in the fourth example, and is provided with an equatorial erase head 21. In this example, the write head 20 is pulsed to produce binary patterns of surface magnetism 23. In this example, the output signal 15 from the sensors 13 will also be pulsed.

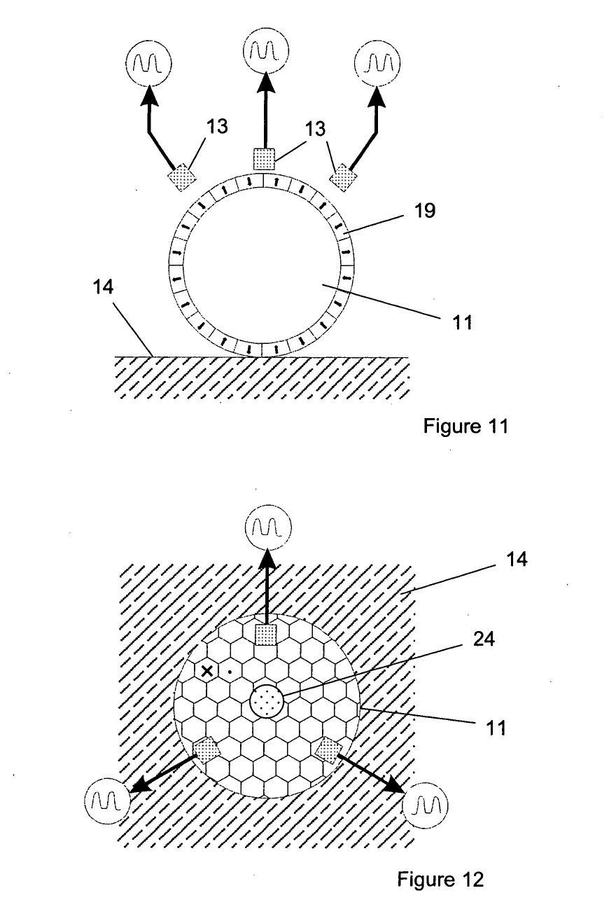

In FIGS. 11 and 12, the ball 11 in the sixth example is provided with a predefined pattern of magnetisation in the surface coating 19 such that the surface comprises an array of individual dipoles. The sensors 13 are able to detect the movement of the predefined pattern of dipoles as the ball 11 is rotated. An optional central “reference” sensor 24 could also be provided to enhance the accuracy of the readings.

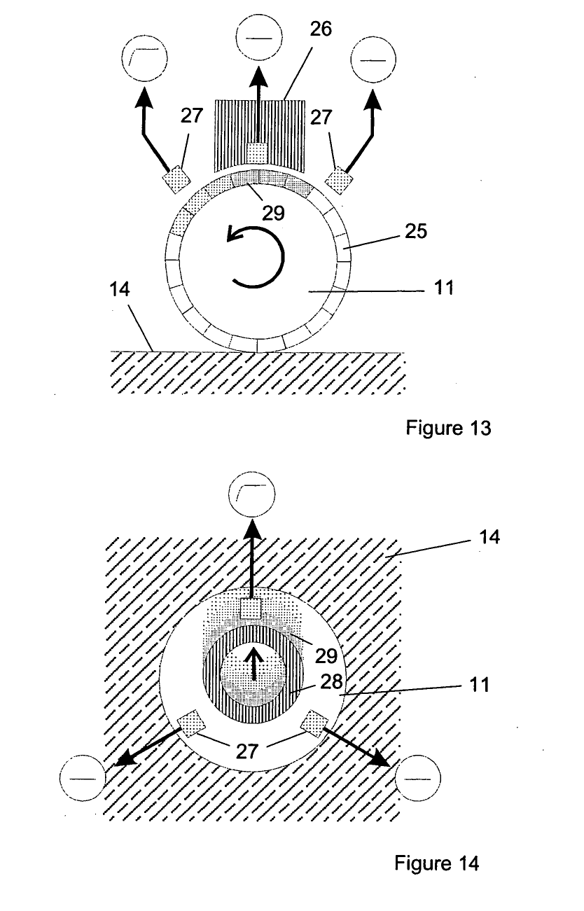

The seventh example shown in FIGS. 13 and 14 has a ball 11 on which a surface activatable coating 25 is provided. The coating may be phosphorescent, thermochromic or thermal and is activated by an activation source 26 which may be a heat or a light source. The sensors 27 may be either heat or light sensors depending upon the activation source. The activation source is typically mounted in a solid or hollow tube 28 and provides a localised area of activation 29 on the surface of the ball 11 which can be detected by the sensors. The activation decays at a known rate and this can be used in determining the direction and speed of rotation of the ball 11.

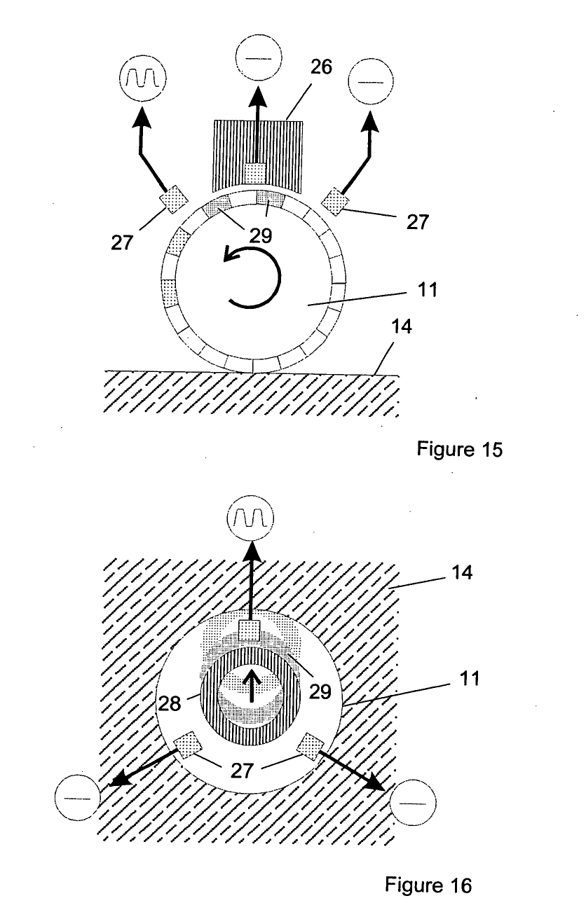

The eighth example shown in FIGS. 15 and 16 is identical to that of the seventh example but in this arrangement, the activation source is pulsed to provide a differently shaped activation region on the surface of the ball 11.

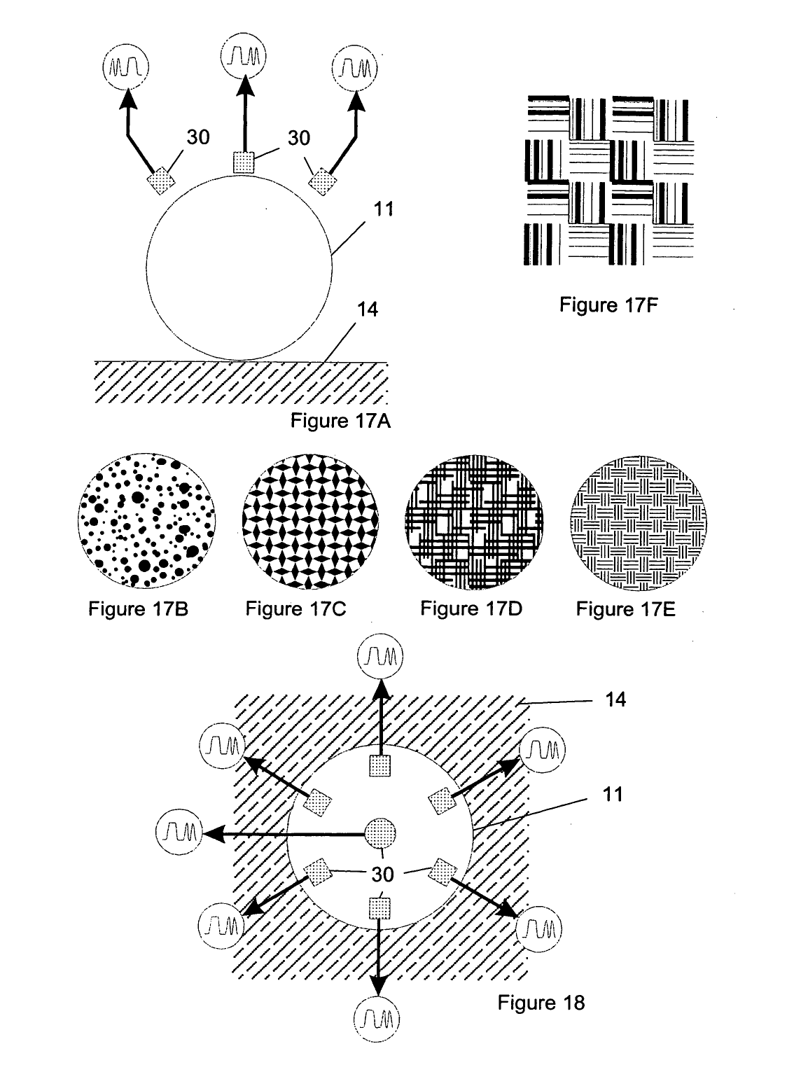

The ninth example shown in FIGS. 17A to F and FIG. 18 comprises optical sensors 30 for the detection of a pattern on the surface of ball 11. Different forms of patterns as shown in FIG. 17B to F and could be, respectively, random, tessellated, line patterns or micro coded.

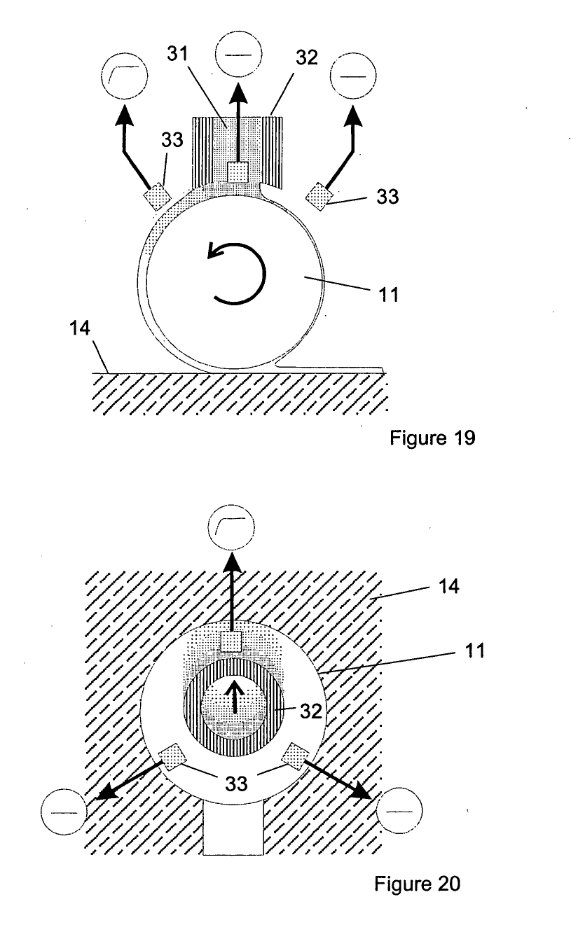

FIGS. 19 and 20 show the tenth example of the present invention in which ink 31 is supplied to the ball 11 and can be deposited on the surface 14 in a manner well known from previous writing implements. However, in this example, an activation source 32 is provided to alter the properties of the ink for example, using heat, light or magnetic field to alter the ink temperature, phosphorescence or magnetic alignment of particles in the ink. The sensors 33, which are of whatever form necessary to detect the specific activation, detect the change in the activation field as the ball rotates due to the decay in the activation.

In particular, the ink may contain magnetisable particles which are locally oriented by the activation source 32 as the ink is drawn out on to the ball 11. The detection, in this case, would be by a magnetic sensor. The magnetic alignment will be lost when the ink is passed to the surface 14. Although not shown, it is envisaged that the thickness of the ink film could be detected to provide an indication of the rotation of the ball 11 and this can be done capacitively, based upon the ink permeability, or optically, based upon the ink optical density.

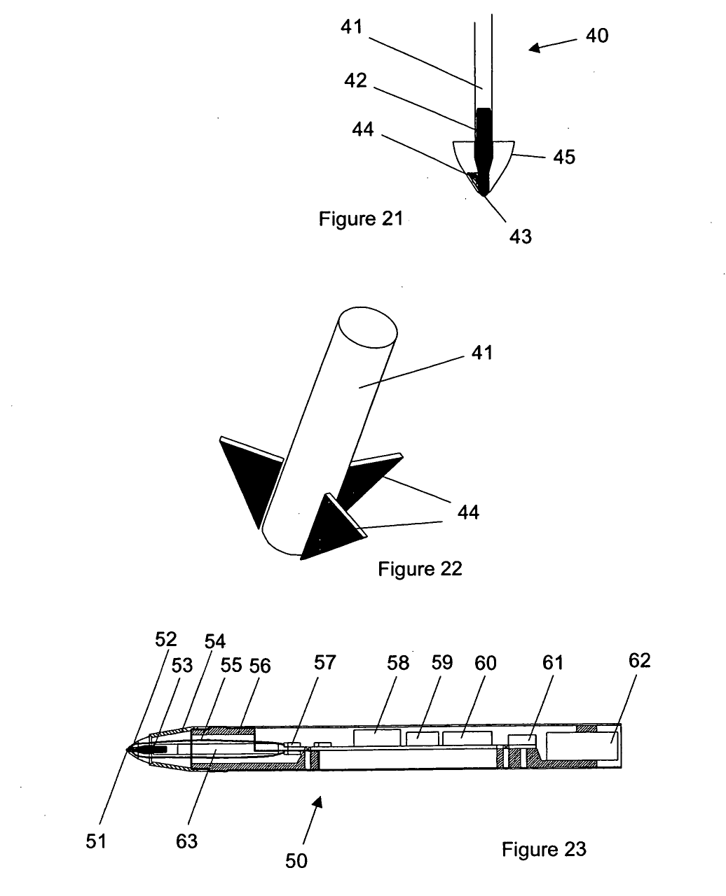

FIGS. 21 and 22 shows schematic arrangements of tips which could be used in a writing implement using the sensor arrangement shown in FIGS. 19 and 20.

In particular, FIGS. 21 and 22 show a refill tip 40 which includes a refill cartridge 41 for the supply of ink, a brass tip insert 42, through which the ink can flow to tip 43. Transducers 44 are provided at spaced intervals around the circumference of the refill and are shaped so that they fit within the tip casing 45 of a writing implement.

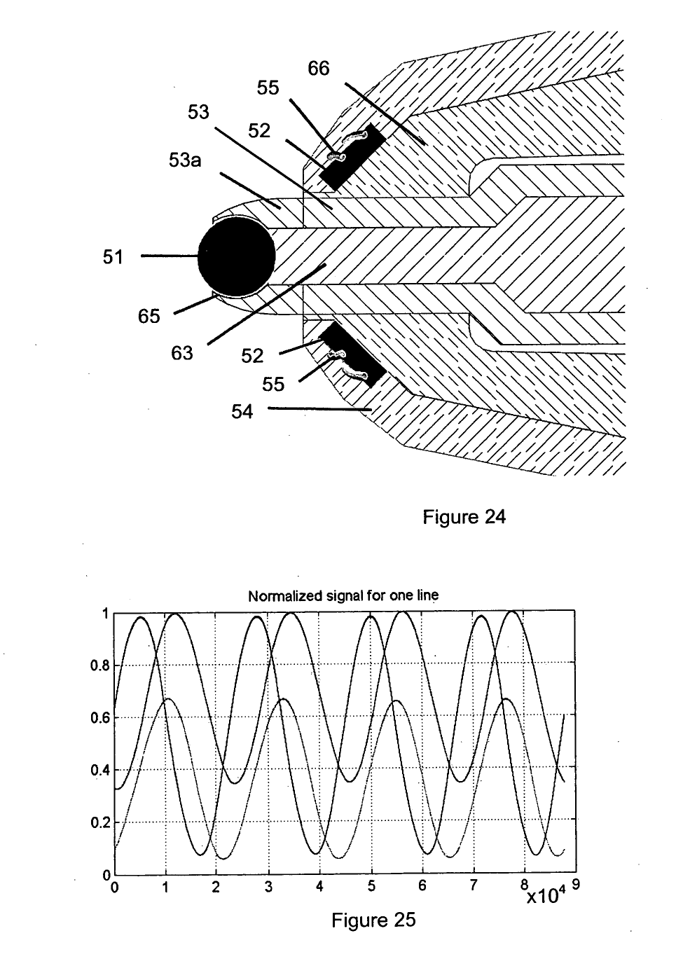

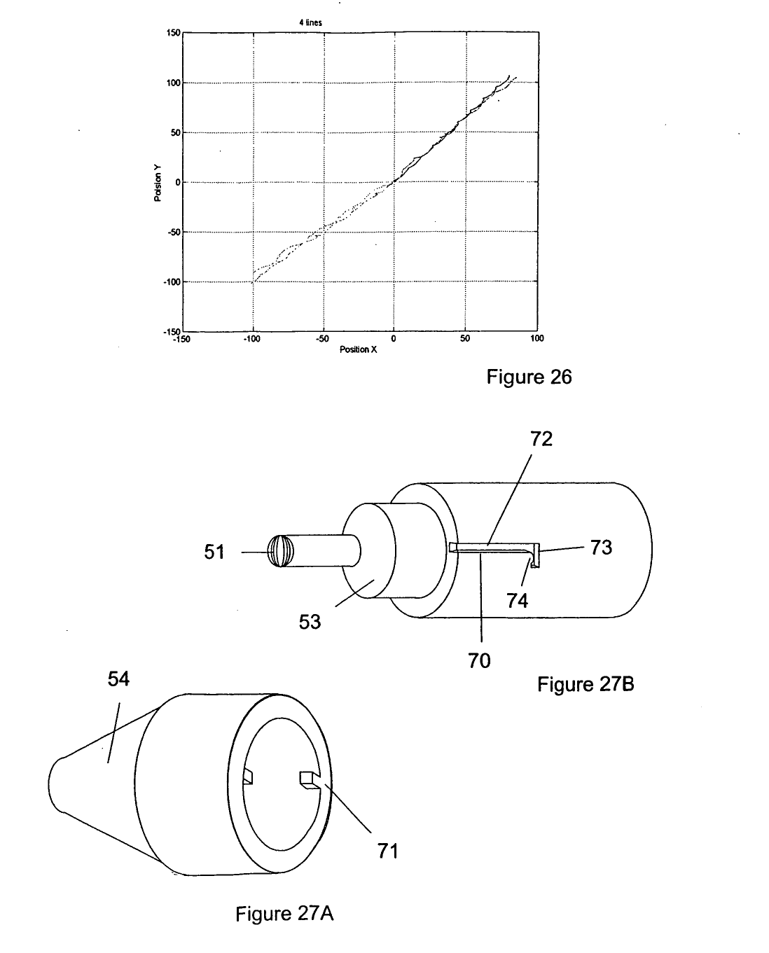

FIGS. 23 and 24 shows an implement 50 that converts hand writing into typed text that appears within an application on a host processor. The rollerball 51 is housed within a standard rollerball ink refills 53 which is held accurately, as shown in FIGS. 27a and 27b, with respect to the sensors 52 located within the pen body. The sensors 52 are mounted on a carrier 66, encapsulated in epoxy (Ciba Geigy 2019) and encased in a plastic protective conical shroud 54.

A rollerball 51 is made of Ruballoy, a standard alloy of tungsten carbide (containing 72% WC, 20% Co, 5% Cr). It is typically of 1.0 mm diameter. The rollerball is magnetised before assembly with a uniform dipole by exposure to a saturating linear magnetic field produced by an electromagnet coil.

A rollerball housing 53a at one end of the refill 53 is brass, a standard pen tip material that is non-magnetic. There is a small amount of free space 65 between the rollerball 51 and housing 53a to allow ink 63 to flow and the rollerball to roll.

The rollerball housing 53a encapsulates the rollerball to just beyond its equator in order for the rollerball to be captive within the housing.

The sensors 52 are Anisotropic MagnetoResistive (AMR) sensors used in a bridge configuration. The magnetic field strength can be detected by applying a voltage to the bridge containing a number of these AMR sensors and measuring the voltage offset generated.

In this example, three sensors are used. They are arranged with rotational symmetry about the longitudinal axis of the pen at an angle of 45° to this axis with the active face of the sensor being directed towards the centre of the rollerball.

The sensors 52 are electrically connected to a PCB 67 via connectors 57 using conductors 55 that lead from the sensor positions through the carrier 66 into the main pen body 56. The small voltage differences developed across the sensor are sent via the electrical conductors 55 to operational amplifiers 58 which amplify the signals.

The amplified signals are sent to an analogue to digital converter 59. A microprocessor 60 then processes and compresses the sensor signals. A radio-frequency transmitter module 61 (for example a BlueTooth module) sends the signals via an antenna 62 to an equivalent antenna and receiver module on a host processor (a personal computer or PDA for example)

The vector reconstruction algorithm can be described simply in the following sequence.
Sensor data from the three sensors is acquired by the microprocessor.
The data from each sensor is normalized with respect to the sensors local maximum and minimum values by the microprocessor.
This data is transmitted to the host processor.
The sensor data from the three sensors is used to calculate the magnetic dipole orientation in the magnetized rollerball by the host processor. This gives a measurement of the dipole orientation.
The rotational axis of the rotating magnetized sphere is calculated using a sequence of dipole orientations by the host processor. This gives a measurement of the dipole rotation.
The vector translation of the rollerball along a plane is calculated by the host processor.

FIGS. 27A and 27B show the example of a mechanism by which the alignment of the sensors located on the inside of the shroud 54 and the rollerball 51.

The refill 53 is provided with a guide groove 70, and a corresponding groove directly opposite on the other side of the refill, into which a guide pin 71, located on the inner surface of the shroud 54, is fitted. The grooves 70 are provided with a substantially straight section 72 and a hook portion 73. When the guide pin 71 has reached the end of the straight portion 72, relative rotation of the shroud 54 and the refill 53 causes the guide pin 71 to travel into the hook portion 73. A projection 74 creates a narrowed section 75 through which the guide pin 71 is urged, thereby locking the refill with the shroud.

1-19. (cancelled).

20. A sensing apparatus for detecting a translation of a body relative to a surface, the apparatus comprising:
a rolling component for contact, in use, with the surface, the rolling component being retained by, and able, in use, to rotate independently of the body, the rolling component having a single permanently magnetized dipole; and
at least 3 AMR sensors for producing one or more signals in response to a rotation of the dipole relative to the sensors;
wherein, in use, the rolling component rolls upon the surface in response to a relative translation of the body to the surface, thereby causing the positional orientation of the dipole to change with respect to the sensors.

21. A sensing apparatus according to claim 20, further comprising means for detecting temporary breaks in the movement of the rolling component when it is lifted from the surface.

22. A sensing apparatus according to claim 21, wherein the means for detecting temporary breaks in the movement of the rolling component when it is lifted from the surface is a pressure sensor.

23. A sensing apparatus according to claim 20, wherein there is only one axis of rotation.

24. An implement including a sensing apparatus according to claim 20, wherein the sensing apparatus is located in a tip of the implement and is used to track the motion of the tip over the surface.

25. An implement according to claim 24, in which said tip is fed with ink which is then deposited onto the surface as the rolling component moves along the surface.

26. An implement including a sensing apparatus according claim 20, wherein the rolling component is located in a sensing point of the implement and is used to sense and track the motion of a surface in relation to the sensing point.

27. An implement according to claim 26, in which the sensing point is fed with ink which is then deposited onto the surface as the rolling component moves along the surface.

28. An implement according to claim 20, wherein the rolling component is located in a ball and socket articulating joint.

29. An implement according to claim 24, wherein the implement includes a housing to which the sensors are mounted and a removable structure, interconnected with the housing, on which the rolling component is mounted.

30. An implement according to claim 24, wherein the housing and the removable structure are connected by means of a bayonet fitting.
